(19) United States
(12) Patent Application Publication
(10) Pub. No.: US 2003/0081123 A1
(43) Pub. Date: May 1, 2003

(54) Video and data documenting system for a public service vehicle

(76) Inventor: Steven M. Rupe, Ontario, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 10/281,679

(22) Filed: Oct. 28, 2002

Related U.S. Application Data
(60) Provisional application No. 60/345,986, filed on Oct. 26, 2001.

(51) Int. Cl. H04N 7/18

(52) U.S. Cl. 348/148

(57) ABSTRACT

A video and data documenting system of a public service vehicle including: a video camera mounted within the vehicle; a platform mounted within the vehicle to the roof of the vehicle, the platform extending from a forward point approximate the front windshield of the vehicle to at least a mid-point approximate a backrest portion of affront seat of the vehicle; a control box mounted to the platform approximate the forward point of the platform; a video recorder box, housing a video recorder therewithin, mounted to the platform approximate the mid-point of the platform; and, data lines and associated control circuitry operatively coupling the video camera, control box and video recorder together and controlling the operations of the video camera, control box and video recorder with respect to one another, whereby, the control box and video recorder box are accessible by an operator of the vehicle sitting in the front seat of the vehicle.

### REFERENCE TO RELATED APPLICATION

This application claims the benefit of U.S. Provisional Application Serial No. 60/345,986, entitled “VIDEO AND DATA DOCUMENTING SYSTEM FOR A PUBLIC SERVICE VEHICLE”, filed on Oct. 26, 2001, the disclosure of which is incorporated herein by reference.

### BACKGROUND

1. Field of the Invention

The present invention is directed to video and data documenting systems, and in particular video and data documenting systems for a public service vehicle such as, without limitation, police department vehicles, fire department vehicles, and public maintenance vehicles.

2. Background of the Invention

In law enforcement, the routine traffic stop may be safe or one of the most dangerous situations encountered by law enforcement personnel. This is particularly true where the motorist is stopped in a relatively isolated area by a single police officer. In such situations, the police officer is vulnerable to attack. Police officers in such circumstances have been verbally abused, attacked, and in some instances killed. Typically, there are no witnesses to such attacks, making it difficult to determine what actually happened. Often times, if the attack on the police officer is fatal, the case remains unsolved for lack of witnesses or other clues.

Video surveillance systems for police vehicles are well known in the art. These systems generally included a video camera mounted to the interior of the windshield or the interior roof of the vehicle. The video output line was connected to a video recorder within the trunk of the vehicle, thereby keeping the video recorder isolated and relatively free from damage. The video recorder was most often a videocassette recorder (VCR) having a portable cassette that was inserted at the beginning of the officer's shift, and removed following the end of the officer's shift. Alternative video surveillance systems and surveillance components have been the subject of United States Patents.

For example, U.S. Pat. No. 4,789,904 discloses a vehicle mounted surveillance system that comprises: a video camera; a video recorder; a control head for operator control by a person in the vehicle; a vault for housing the video recorder; a power supply for providing power for operating the camera, the video recorder and the control head; and, connector means for interconnecting the camera, the video recorder and the control head to form a surveillance system operatively connected to the power supply to enable on/off operation.

U.S. Pat. No. 4,949,186 discloses a method of providing a record of events utilizing a vehicle mounted surveillance system, comprising the steps of: mounting and positioning a camera supported by a vehicle for viewing a selected scene outside of the vehicle; positioning a video recorder within the vehicle operatively connected to the video camera; mounting control means within the vehicle wherein the control means is operatively connected to the camera and the video recorder for operation thereof by a person riding in the vehicle; securing the video recorder within a vault mounted within the vehicle; and, operating the camera, the video recorder and the control means from the power supply system of the vehicle.

U.S. Pat. No. 6,333,759 discloses a non-rotational, unitary video system for an automotive vehicle comprising: a video camera housing located inside an automotive vehicle including a plurality of video cameras, located on each side of housing to provide a 360 degree range for simultaneous video recording of images received by the lenses, the camera housing being separate from a rear view mirror housing and each of the cameras being located apart from each other; a video multiplexer for multiplying all recorded video images by said cameras; and, a video camera recorder for recording images multiplexed by the multiplexer thereby providing a recording of an environment surrounding the camera housing.

### SUMMARY

A first aspect of the present invention is directed to a video and data documenting system for a public service vehicle that includes: a video camera mounted within the vehicle; a platform mounted within the vehicle to the roof of the vehicle, where the platform extends from a forward point approximate the front windshield of the vehicle to at least a mid-point approximate a back rest portion of the front seat of the vehicle; a control box mounted to the platform approximate the forward point of the platform; a video recorder box, housing a video recorder therewithin, mounted to the platform approximate the mid-point of the platform; and, data lines and associated control circuitry operatively coupling the video camera, control box and video recorder together and controlling the operations of the video camera, control box and video recorder with respect to one another; whereby, the control box and video recorder box are accessible by an operator of the vehicle sitting in the front seat of the vehicle. In a more detailed embodiment, the video recorder includes a removable video storage device, which may be an analog videotape or a digital memory.

In an alternate detailed embodiment of the first aspect of the present invention, the control box includes a first LED facing the front windshield and the control circuitry is operative to activate the first LED upon activation of the video camera. In a further detailed embodiment, the system further includes a microphone operatively coupled to the control box and video recorder by the data lines and associated control circuitry, where the control box further includes a second LED facing the front windshield and wherein the control circuitry is operative to activate the second LED upon activation of the microphone.

It is a second aspect of the present invention to provide a video and data documenting system for a public service vehicle that includes: a first video camera mounted within the vehicle; a control box mounted within the vehicle, accessible by an operator of the vehicle sitting in a front seat of the vehicle; a digital recorder, including a digital removable memory; and, data lines and associated control circuitry operatively coupling the first video camera, control box and video recorder together and controlling the operations of the first video camera, control box and video recorder with respect to one another. In a detailed embodiment, the data lines include wireless data lines. In yet a further detailed embodiment, the system further includes a second video camera having a wireless video transmitter, operatively coupled to the control box and recorder via the wireless data lines and associated control circuitry. In a further detailed embodiment, the control circuitry coordinates video data from the first and second video cameras with respect to each other and stores the coordinated video data on the removable digital memory. Optionally, the second video camera may be mounted within or to a hand-held multi-function device that includes a visible light illuminator. The multi-function device may include an integral display screen operatively coupled to the second video camera for displaying, at least in part, video images captured by the second video camera. It is also an option that the multifunction device may further include an infrared illuminator and the video camera may be an infrared video camera. It is also possible for the control box to include a display screen operatively coupled to the first and second video cameras and to the control circuitry for displaying images captured by the first and second video cameras, where such video images may be displayed simultaneously on the display screen.

In an alternate detailed embodiment of the second aspect of the present invention, the data lines include data lines coupled to operational and/or sensing components of the vehicle. Such operational components may include, for example, flashing lights, sirens, headlights, brakes, turn signals, and the like. Such sensing components may include, for example, speed sensors, RPM sensors, gas gauges, and the like. In a further detailed embodiment, the control circuitry coordinates video data from the first video camera with data from the sensing components and operational components and stores the coordinated data on the removable digital memory.

In an alternate detailed embodiment to the second aspect of the present invention, the digital recorder may be remote from the vehicle. In another alternate detailed embodiment of the second aspect of the present invention, the system may further include a wireless transmitter operatively coupled to the first video camera, control circuitry and/or digital recorder that transmits, at least in part, video data captured by the first video camera, and a monitoring station remote from the vehicle, where the monitoring station includes a wireless receiver receiving the video data transmitted by the wireless transmitter.

It is the third aspect of the present invention to provide a video and data documenting system for a public service vehicle that includes: a first video camera mounted within the vehicle; a control box mounted within the vehicle and operatively coupled to the first video camera; a wireless transmitter operatively coupled to the control box for transmitting, at least in part, video data from the first video camera; and, a monitoring station remote from the vehicle and including a wireless receiver receiving video data transmitted by the wireless transmitter. In a detailed embodiment, the system further includes a second video camera having a wireless video transmitter, operatively coupled via a wireless data line to the control box, wherein the wireless transmitter transmits, at least in part, video data from the first and second video cameras to the monitoring station. In a further detailed embodiment, the video station coordinates video data from the first and second video cameras with respect to each other and stores the coordinated video data in digital memory. Optionally, the second video camera may be mounted within or to a hand-held multi-function device that includes a visible light illuminator. As discussed above, the multi-function device may include an integral display screen operatively coupled to the second video camera for displaying, at least in part, video images captured by the second video camera.

In an alternate detailed embodiment of the third aspect of the present invention, the system may further include data lines coupled between operational and/or sensing components of the vehicle and the wireless transmitter. Such operational components may include, for example, flashing lights, sirens, headlights, brakes, turn signals, and the like. Such sensing components may include, for example, speed sensors, RPM sensors, gas gauges, and the like. The wireless transmitter transmits, at least in part, data from the operational and sensing components along with the video data to the monitoring station. In a further detailed embodiment, the monitoring station coordinates video data from the first camera with data from the sensing and operational components and stores the coordinated data in digital memory.

It is the fourth aspect of the present invention to provide a hand-held multi-function device that includes: a housing including a handle portion; a visible light illuminator coupled to the housing, emitting light in a lighting direction; a video camera mounted to the housing and positioned to point in the lighting direction; a wireless transmitter operatively coupled to the video camera; a power source operatively coupled to the visible light illuminator, the video camera, and the wireless transmitter; and, controls integrated with the housing for selectively activating the visible light illuminator and the video camera. In a further detailed embodiment, the housing is in the form of a conventional flashlight having a cylindrical handle portion and a conical-shaped illumination portion where the conical-shaped illumination portion contains the visible light illuminator as well as the video camera. In yet a further detailed embodiment, the multi-function device includes a display screen positioned between the handle portion and the illumination portion, operatively coupled to the video camera for displaying, at least in part, video data captured by the video camera.

### BRIEF DESCRIPTION OF THE DRAWINGS

FIG. 1 is a perspective view, from below, of an exemplary embodiment according to the present invention;

FIG. 2 is another perspective view, from below and to the side, of the exemplary embodiment according to the present invention mounted within a vehicle;

FIG. 3 is another perspective view, from below and to the side, of the exemplary embodiment according to the present invention mounted within a vehicle;

FIG. 4 is an overhead view of an exemplary platform that may be utilized with the present invention;

FIG. 5 is a profile view of an exemplary platform that may be utilized with the present invention;

FIG. 6 is a schematic block diagram of an exemplary video system according to the present invention;

FIG. 7 is a side view of another exemplary embodiment according to the present invention;

FIG. 8 is a front end view of the other exemplary embodiment according to the present invention; and,

FIG. 9 is a schematic block diagram of another exemplary video system according to the present invention.

### DETAILED DESCRIPTION

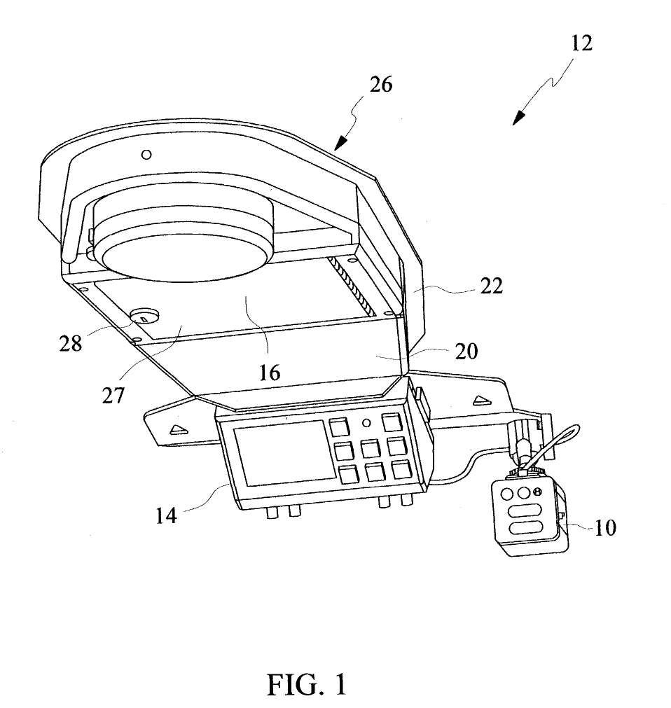

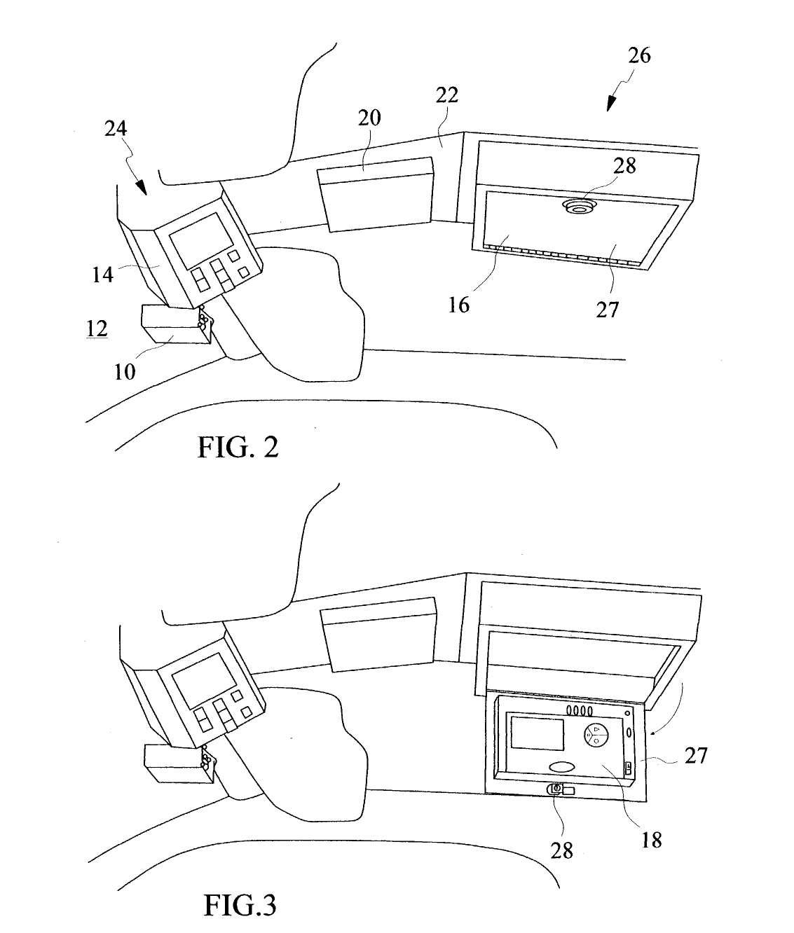

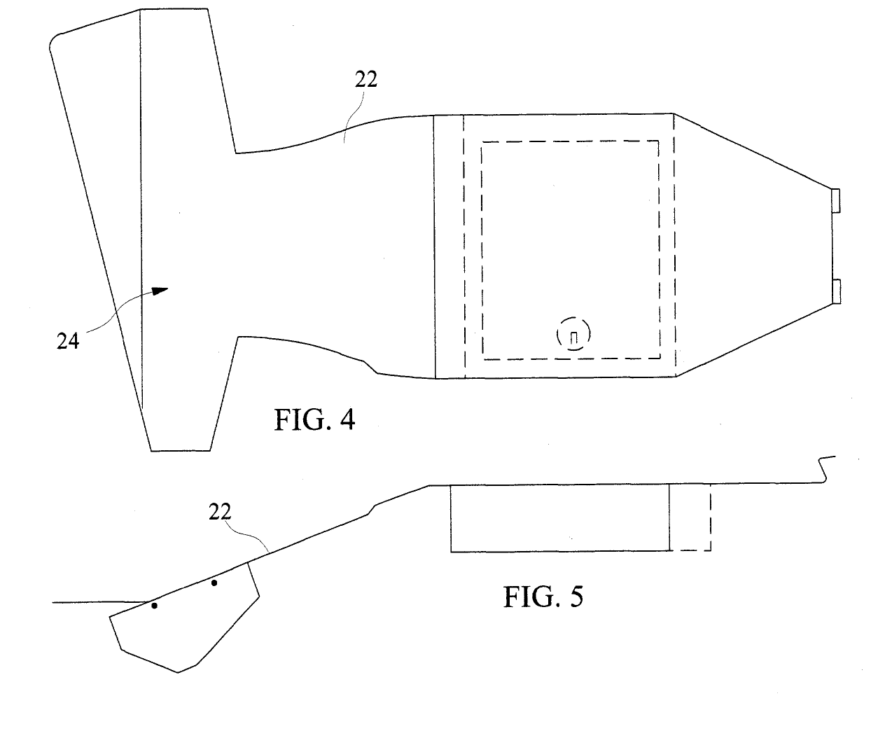

FIGS. 2 and 3 illustrate an interior view of a police vehicle in which an exemplary embodiment of the video and data documenting system of the present invention has been installed. Referencing FIGS. 1-3, the video and data documenting system of this exemplary embodiment includes a video camera 10 mounted within the vehicle and facing forward through the front windshield 12 of the vehicle; a control box 14, a video recorder box 16 housing a SONY® EVO250® video recorder 18, for example, therein and a maintenance box 20 containing circuitry and other components. The control box 14, video recorder box 16 and maintenance box 20 are all mounted to a platform 22 (see FIGS. 4 and 5), which, in turn, is mounted to the roof of the vehicle such that a forward section 24 of the platform is approximate the front windshield 12 and such that a mid-section 26 is approximate a back rest of a front seat of the vehicle (not shown), or in other words, is near the driver's or front-seat passenger's head. In the present embodiment, the platform 22 is positioned midway between the passenger side and the driver side so that either front seat operator (i.e, driver or front seat passenger) may access the control box 14 or the video recorder box 16 while sitting in their respective seats. Nevertheless, it is within the scope of the invention that at least the driver has access to the control box.

As shown in FIGS. 1-3, the recorder box 16 includes a hinged door 27 onto which is mounted the video recorder 18 such that when the hinged door 27 is opened and swings downwardly on the hinges, the video recorder 18 is easily accessed by the driver. Additionally, the hinged door 27 includes a lock 28 for protecting the contents from unauthorized access.

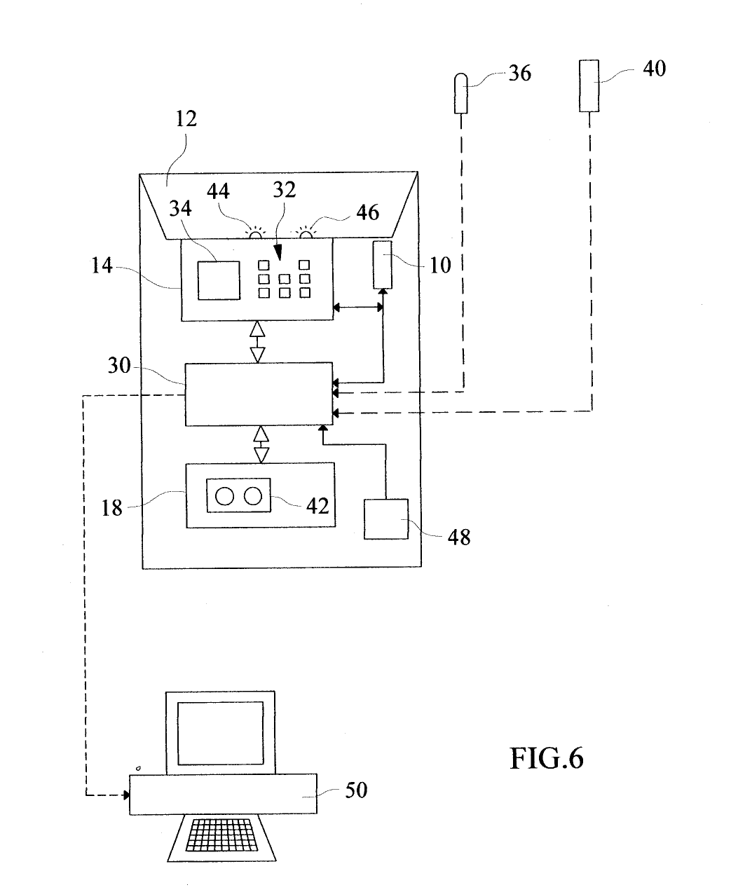

Referring to FIG. 6, which is a schematic block diagram of the video system according to the present invention, the control box 14 is operationally coupled to the control circuitry 30 and to the video recorder 18. The video camera 10 is operationally coupled to the control box 14 and/or the control circuitry 30. The control box 14 includes buttons/switches 32 for controlling the operation of the system and includes a display screen 34. Optionally, the system includes a wireless microphone 36 carried by the operator of the system while within and outside of the vehicle. This wireless microphone 36 is operationally coupled to the system via a wireless transmitter and receiver. It is also within the scope of the invention that the system includes a second wireless video camera 40 that may also be carried by the operator of the system (police officer) outside the vehicle. This second camera 40 is also operatively coupled to the system via wireless transmitters and receivers. It will be apparent to those of ordinary skill that additional wireless or wired microphones or video cameras may be incorporated into the system as desired. For example, additional microphones and cameras may be placed/mounted in the back seat or rear cabin of the vehicle.

The control circuitry 30 controls the operations of the various components of the system and coordinates the data received from the various inputs (such as the video cameras and microphones) for storing the coordinated data on a removable memory device 42 and for displaying the video captured by the cameras on the display screen 34. Of course, it is within the scope of the invention that the control circuitry 30, or portions thereof, may be incorporated into the control box 14 and/or the video recorder 18. The removable recording device 42 may be an analog tape or a digital memory device such as a diskette or a MEMORY STICK®, for example. The display may display single video images or multiple video images depending upon the configuration of the system.

Preferably, the control box 14 includes an LED 44 positioned on a face of the control box such that the LED can be seen through the front windshield 12. This LED is activated when the camera 10 is operating so that operators of the system will be able to see and assure themselves that the camera 10 is operating when they are outside of the vehicle. A second LED 46 positioned in the same manner as the first LED indicates to the operator that the microphone 36 is operating.

The control circuitry 30 may also be set up to receive data from operational and/or sensing components 48 of the vehicle. Examples of operational components may include flashing lights, sirens, headlights, brakes, turn signals, and the like; and sensing components may include speed sensors, RPM sensors, gas gauges, and the like. The control circuitry 30 may be configured to coordinate this data with the data from the cameras 10 and 40 and the microphones 36. Such coordinated data may be stored with the video data on the removable memory device 42. An example of coordinated data is data organized with respect to time, such as chronological data.

It is also within the scope of the invention that the system include a wireless link between the system and to a remote monitoring station 50 which would be set up to receive the video data, microphone data, and other operational and/or sensing data in real time for monitoring by a dispatcher or some other supervisory personnel and/or for recordation on permanent or temporary storage devices at the remote location. With such a remote monitoring station 50, it is possible to eliminate the need for the in-vehicle video recorder 18.

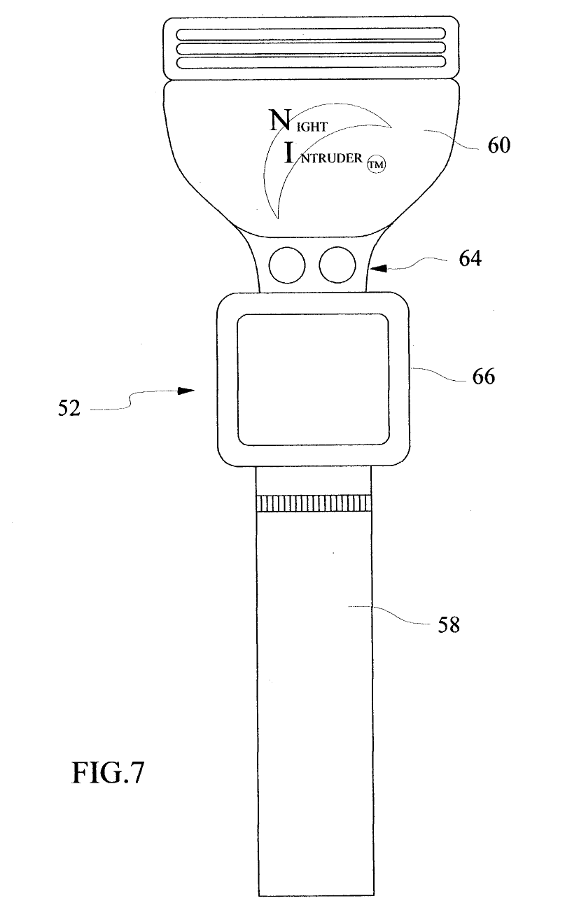

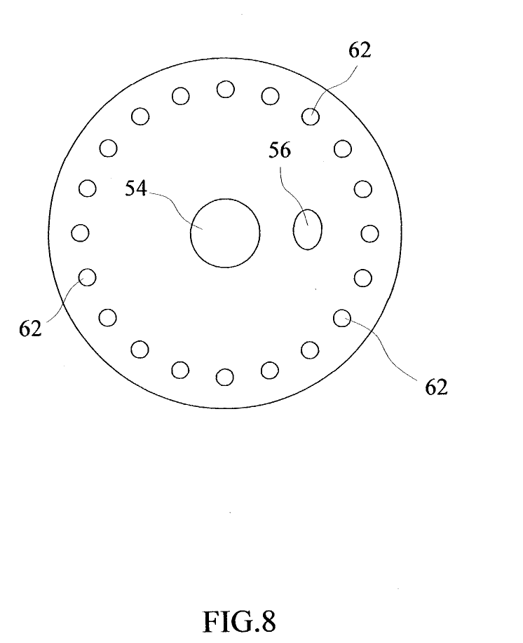

FIGS. 7 and 8 show an exemplary embodiment of a hand-held multi-function device 52 according to the present invention, which incorporates a wireless video camera 54 and a microphone 56 therein. The exemplary embodiment of the multi-function device 52 is in the shape of a conventional flashlight having a cylindrical handle portion 58 and a conical illumination portion 60. The conical illumination portion 60 contains a visible light illumination component 62 (such as a light bulb or light emitting diode, LED) and the video camera 54 approximate its proximal region. Exemplary structures for the device 52 may be flashlight housings manufactured by CPD Industries or by Mag Instrument Inc.

The video camera 54, in the exemplary embodiment, is Sony processor based and provides zoom capabilities, and may also provide infrared image detection. The camera additionally may be coupled to a digital medium, such as, without limitation, a digital recording card. An example of such a digital recording card is a solid state flash card, such a MEMEORY STICK®. Referring specifically to FIG. 8, an exemplary orientation might have the video camera 54 centered within a ring of visible light LEDs 62. A series of infrared LEDs may also be included if not integrated with the camera 54. The SONY® IX 10® is an exemplary camera 54 for use with the present invention.

Buttons 64 are positioned between the handle portion 54 and conical illumination portion 60 to allow selection between visible or infrared video capture by the video camera 54. Alternatively, the video camera 54 may include electronics that automatically differentiate between optimal infrared recording or visible light recording conditions. The buttons 64 also enable activation of the, video camera 54 concurrently with the microphone 56. Additionally, the buttons 64 may provide control over the video zoom feature of the camera 54.

The hand-held multi-function device 52 is preferably powered by a rechargeable battery contained within the handle portion; although, other mobile power sources may be utilized, such as, without exception, disposable batteries or a wired mobile power unit carried by the user. An optional LCD monitor 66 may also be incorporated with the device 52 to provide a display for viewing video captured by the camera 54.

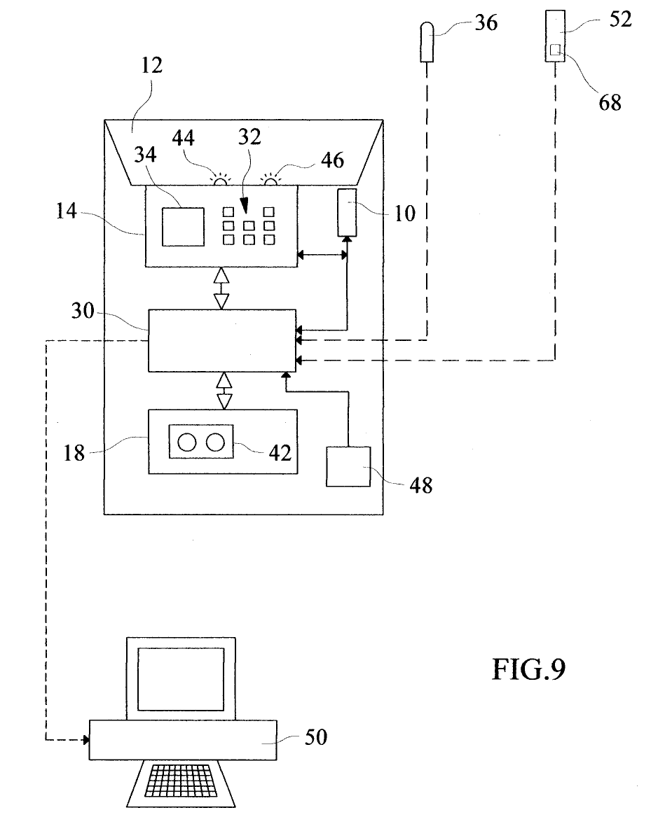

Referencing FIG. 9, it is also within the scope of the present invention to integrate the hand-held multi-function device 52 with one or more of the previously explained exemplary embodiments. The control circuitry 30 includes a dual reception feature such that depression of a button, associated with the control box 14, operatively couples the control circuitry 30 with the hand-held multi-function device 52. The control circuitry 30 may receive data from the hand-held multi-function device 52 in a wired or wireless form. Exemplary wireless transmission forms include data transmitted over 800-900 mHz, 1.5 gHz and 2.4 gHz frequencies.

It is also within the scope of the invention that the system include a wireless link between the hand-held multi-function device 52 and to a remote monitoring station 50 which would be set up to receive the video data, microphone data, and other operational and/or sensing data in real time for monitoring by a dispatcher or some other supervisory personnel and/or for recordation on permanent or temporary storage devices at the remote location. The device 52 may also include a “panic” button to notify the monitoring station that help is needed immediately. In accordance with the monitoring feature, the hand-held multi-function device 52 may include a global positioning system (GPS) 68 such as the GARMIN® ETREX VISTA®) and the GARMIN® GPSMAP 76S®, thereby allowing the remote monitoring station 50 to determine the location of the hand-held multi-function device 52 and user. Other GPS systems manufactured by MAGELLAN® and GARMIN® are also within the scope of the present invention.

Following from the above description and invention summaries, it should be apparent to those of ordinary skill in the art that, while the methods and apparatuses herein described constitute exemplary embodiments of the present invention, it is to be understood that the inventions contained herein are not limited to these precise embodiments and that changes may be made to them without departing from the scope of the inventions as defined by the claims. Additionally, it is to be understood that the invention is defined by the claims and it not intended that any limitations or elements describing the exemplary embodiments set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A video and data documenting system of a public service vehicle comprising:
a video camera mounted TO a vehicle;
a platform mounted within the vehicle to the roof of the vehicle, the platform extending from a forward point approximate the front windshield of the vehicle to at least a midpoint approximate a backrest portion of a front seat of the vehicle;
a control box mounted to the platform approximate the forward point of the platform;
a video recorder box, housing a video recorder therewithin, mounted to the platform approximate the mid-point of the platform; and
data lines and associated control circuitry operatively coupling the video camera, control box, and video recorder together and controlling the operations of the video camera, control box, and video recorder with respect to one another;
whereby, the control box and video recorder box are accessible by an operator of the vehicle sitting in the front seat of the vehicle.

2. The video and data documenting system of claim 1, wherein the video recorder includes a removable video storage device.

3. The video and data documenting system of claim 2, wherein the video storage device is an analog video tape.

4. The video and data documenting system of claim 2, wherein the video storage device is a digital memory device.

5. The video and data documenting system of claim 1, further comprising a first LED facing the front windshield operatively coupled to the control circuitry, which is operative to activate the first LED upon activation of the video camera.

6. The video and data documenting system of claim 5, further comprising:
a mic operatively coupled to the control box and video recorder by the data lines and associated control circuitry; and,
a second LED facing the front windshield and operatively coupled to the control circuitry, which is operative to active the second LED upon activation of the mic.

7. The video and data documenting system of claim 1, wherein at least a portion of the data lines and associated control circuitry are housed within a maintenance box mounted to the platform between the control box and video recorder box.

8. A video and data documenting system for a public service vehicle comprising:
a first video camera mounted to a vehicle;
a control box mounted within the vehicle, accessible by an operator of the vehicle sitting in a front seat of the vehicle;
a digital recorder, including a removable digital memory;
data lines and associated control circuitry operatively coupling the first video camera, control box, and video recorder together and controlling the operations of the first video camera, control box, and video recorder with respect to one another.

9. The video and data documenting system of claim 8, wherein the data lines include wireless data lines.

10. The video and data documenting system of claims 8 or 9, further comprising a second video camera having a wireless video transmitter, operatively coupled to the control box and recorder via the data lines and associated control circuitry.

11. The video and data documenting system of claim 10, wherein the control circuitry coordinates video data from the first and second video cameras with respect to each other and stores the coordinated video data on the removable digital memory.

12. The video and data documenting system of claim 10, wherein the second video camera is mounted to a hand-held multi-function device that includes a visible light illuminator.

13. The video and data documenting system of claim 12, wherein the multi-function device includes an integral display screen operatively coupled to the second video camera, for displaying, at least in part, video images captured by the second video camera.

14. The video and data documenting system of claim 12, wherein the multi-function device further includes an infrared illuminator.

15. The video and data documenting system of claims 10 or 14, wherein the second video camera is an infrared video camera.

16. The video and data documenting system of claim 10, wherein the control box includes a display screen operatively coupled to the first and second video cameras and to the control circuitry for displaying images captured by the first and second video cameras.

17. The video and data documenting system of claim 16, wherein the control circuitry is configured to display video images captured by the first and second video cameras simultaneously on the display screen of the control box.

18. The video and data documenting system of claims 8, 16 or 17, wherein:
the data lines include data lines coupled to an operational component and a sensing component of the vehicle;
the operational component is taken from the group consisting of a flashing light, a siren, a head-light, a brake, and a turn-signals; and,
the sensing component is taken from the group of a speed sensor, an RPM sensor, and a gas gauge.

19. The video and data documenting system of claim 18, wherein the control circuitry coordinates video data from the first video camera with data from the sensing component and the operational component and stores the coordinated data on the removable digital memory.

20. The video and data documenting system of claims 8 or 19, wherein the digital video recorder is remote from the vehicle.

21. The video and data documenting system of claims 8 or 19, further comprising:
a wireless transmitter operatively coupled to at least one of the first video camera, control circuitry, and digital recorder, transmitting, at least in part, video data captured by the first video camera; and,
a monitoring station remote from the vehicle, the monitoring station including a wireless receiver receiving the video data transmitted by the wireless transmitter.

22. A video and data documenting system for a public service vehicle comprising:
a first video camera mounted to a vehicle;
control circuitry mounted to the vehicle and operatively coupled to the first video camera;
a wireless transmitter operatively coupled to the control circuitry for transmitting, at least in part, video data from the first video camera; and,
a monitoring station remote from the vehicle and including a wireless receiver receiving video data transmitted by the wireless transmitter.

23. The video and data documenting system of claim 22, further comprising a second video camera having a wireless video transmitter, operatively coupled to the control circuitry via a wireless data line, wherein the wireless video transmitter transmits, at least in part, video data from the first and second video cameras to the monitoring station.

24. The video and data documenting system of claim 23, wherein the monitoring station coordinates video data from the first and second video cameras with respect to each other and stores the coordinated video data in digital memory.

25. The video and data documenting system of claims 23 or 24, wherein the second video camera is mounted to a hand-held multi-function device that includes a visible light illuminator.

26. The video and data documenting system of claim 25, wherein the multi-function device includes an integral display screen operatively coupled to the second video camera, for displaying, at least in part, video images captured by the second video camera.

27. The video and data documenting system of claim 25, wherein the multi-function device further includes an infrared illuminator.

28. The video and data documenting system of claim 22, further comprising:
data lines coupled between an operational component and a sensing component of the vehicle and the wireless transmitter;
the operational component is taken from the group consisting of a flashing light, a siren, a head-light, a brake, and a turn-signals; and,
the sensing component is taken from the group of a speed sensor, an RPM sensor, and a gas gauge.

29. The video and data documenting system of claim 28, wherein the monitoring station coordinates video data from the first video camera with data from the sensing components and operational components and stores the coordinated data in digital memory.

30. A handheld multifunction device comprising:
a housing including a handle portion;
a visible light illuminator coupled to the housing, emitting light in a lighting direction;
a video camera mounted to the housing and positioned to point in the lighting direction;
a wireless transmitter operatively coupled to the video camera;
one or more power sources operatively coupled to the visible light illuminator, the video camera, and the wireless transmitter; and,
controls integrated with the housing for selectively activating the visible light illuminator and the video camera.

31. The handheld multifunction device of claim 30, wherein the housing in the form of a conventional flashlight having a cylindrical handle portion and a conical illumination portion containing the visible light illuminator and the video camera.

32. The handheld multifunction device of claim 30, further comprising, a display screen positioned between the handle portion and the illumination portion, operatively coupled to the video camera for displaying, at least in part, video data captured by the video camera.

33. The handheld multifunction device of claim 30, further comprising an infrared light illuminator integrated with the housing and emitting infrared light in an infrared lighting direction.

34. The handheld multifunction device of claim 30, further comprising a global positioning device operatively coupled to the wireless transmitter for transmitting the position of the handheld device.

35. The handheld multifunction device of claim 30, wherein the wireless transmitter transmits to at least one of a mobile video recording system and a remote stationary recording system.

36. The handheld multifunction device of claim 30, wherein the video camera has digital zoom capabilities.

37. The handheld multifunction device of claim 36, wherein the controls manipulate the digital zoom capabilities.

38. The handheld multifunction device of claim 30, wherein the remote transmitter is replaced with a data storage medium.

39. The handheld multifunction device of claim 30, wherein the power source is at least one of a disposable power source and a rechargeable power source.

40. A video and data documenting system for a public service vehicle comprising:
a first video camera mounted to a vehicle;
a platform mounted within the vehicle to the roof of the vehicle;
a control box mounted to the platform, accessible by an operator of the vehicle sitting in a front seat of the vehicle;
a video recorder, including a removable video cassette; and,
data lines and associated control circuitry operatively coupling the first video camera, control box, and video recorder together and controlling the operations of the first video camera, control box, and video recorder with respect to one another.

41. The video and data documenting system of claim 40, wherein:
the video recorder is a digital recorder; and,
the removable video cassette is a removable digital memory.

42. The video and data documenting system of claim 41, wherein the data lines include at least one wireless data line.

43. The video and data documenting system of claim 41, further comprising a display screen operatively coupled to the first video camera and to the control circuitry for displaying images captured by the first video camera.

44. The video and data documenting system of claim 41, wherein:
the data lines include data lines coupled to an operational component of the vehicle selected from the group consisting of a flashing light, a siren, a head-light, a brake, and a turn-signal; and,
the data lines include data lines coupled to a sensing component of the vehicle selected from the group consisting of a speed sensor, an RPM sensor, and a gas gauge.

45. The video and data documenting system of claim 41, further comprising a second video camera, wherein the data lines and associated control circuitry operatively couple the second video camera, control box, and video recorder together and control the operations of the second video camera, control box, and video recorder with respect to one another.

46. The video and data documenting system of claim 38, wherein the data lines include at least one wireless data line.
